(19) United States
(12) Patent Application Publication
(10) Pub. No.: US 2010/0123392 A1
(43) Pub. Date: May 20, 2010

(54) PLASMA DISPLAY DEVICE

(76) Inventor: Kanda Hiroshi, Suwon-si (KR)

Correspondence Address: CHRISTIE, PARKER & HALE, LLP, PO BOX 7068, PASADENA, CA, 91109-7068, US

(21) Appl. No.: 12/614,385

(22) Filed: Nov. 6, 2009

(30) Foreign Application Priority Data
Nov. 20, 2008 (KR) 10-2008-0115693

(51) Int. Cl. H01J 17/49

(52) U.S. Cl. 313/582

(57) ABSTRACT

A plasma display panel, including: a first substrate; a second substrate; barrier ribs partitioning a space between the first and second substrates to define discharge cells; address electrodes extending along a first direction to correspond to the discharge cells on a surface of the first substrate and covered with a first dielectric layer; first and second electrodes extending along a second direction crossing the first direction on a surface of the second substrate to define a discharge gap at centers of the discharge cells and covered with a second dielectric layer; and a guide portion that corresponds to at least a part of the discharge gap, wherein the second dielectric layer includes, a first dielectric layer section inside a space defined by the guide portion, and a second dielectric layer section on the first dielectric layer section, and wherein a first dielectric constant is smaller than a second dielectric constant.

### CROSS-REFERENCE TO RELATED APPLICATION

This application claims priority to and the benefit of Korean Patent Application No. 10-2008-0115693, filed in the Korean Intellectual Property Office on Nov. 20, 2008, the entire content of which is incorporated herein by reference.

### BACKGROUND OF THE INVENTION

1. Field of the Invention

The present invention relates to a plasma display panel. More particularly, the present invention relates to a plasma display panel that can reduce reactive power by reducing capacitance between display electrodes that perform surface discharge.

2. Description of the Related Art

In general, power consumption of an AC-type plasma display panel (PDP) includes active power consumed when discharge is made and reactive power consumed when the discharge is not made.

When AC voltage is applied to the PDP, the reactive power is consumed to charge electric charges generated depending on the capacitance. Reactive power consumption is determined depending on capacitance C of the PDP and voltage V applied to the PDP (P=CV²).

Primary elements constituting the capacitance of the PDP include a gap between the display electrodes that perform the surface discharge, a dielectric layer between the display electrodes and adjacent to an upper part of the display electrode, and a dielectric constant of a glass substrate. Accordingly, the capacitance needs to be reduced on the display electrode in order to reduce the reactive power.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of an embodiment of the present invention is directed toward a plasma display panel having a decreased reactive power by reducing capacitance between display electrodes that perform surface discharge.

An aspect of an embodiment of the present invention is also directed toward a plasma display panel having a reduced capacitance by forming a dielectric layer having a low dielectric constant between display electrodes that perform surface discharge.

An aspect of an embodiment of the present invention is further directed toward a plasma display panel having an easily and accurately formed dielectric layer having a low dielectric constant between display electrodes that perform surface discharge.

An exemplary embodiment of the present invention provides a plasma display panel that includes a first substrate; a second substrate facing the first substrate; a plurality of barrier ribs partitioning a space between the first substrate and the second substrate to define a plurality of discharge cells; a plurality of address electrodes on a surface of the first substrate facing the second substrate and is covered with a first dielectric layer, the address electrodes extending in a first direction to correspond to the discharge cells; a first electrode and a second electrode extending in a second direction crossing the first direction on a surface of the second substrate facing the first substrate to define a discharge gap corresponding at the centers of a corresponding one of the discharge cells and covered with a second dielectric layer; and a guide portion corresponding to at least a part of the discharge gap, wherein the second dielectric layer includes a first dielectric layer section within a space defined by the guide portion and a second dielectric layer section on the first dielectric layer section, and wherein the first dielectric layer section has a first dielectric constant and the second dielectric layer section has a second dielectric constant larger than the first dielectric constant.

Each of the first electrodes and the second electrodes may include a bus electrode and the guide portion may be defined by the bus electrodes at both sides of the discharge gap and facing each other.

The first electrode and the second electrode may include transparent electrodes between the surface of the second substrate and the bus electrodes, and the guide portion may be further defined by the transparent electrodes at both sides of the discharge gap and facing each other.

The first dielectric layer section may be between the transparent electrodes defining the discharge gap and between the bus electrodes.

A thickness of the first dielectric layer section extending toward the first substrate from the surface of the second substrate may be substantially identical to a sum of a thickness of each of the transparent electrodes and a thickness of each of the bus electrodes.

The first dielectric layer section may extends in the second direction in the discharge gap between the first electrode and the second electrode.

The second dielectric layer section may be on the first dielectric layer section, the bus electrodes, and the transparent electrodes.

The bus electrodes may be a plurality of metallic lines. The metallic lines may include inner lines defining the discharge gap and outer lines at sides of the inner lines away from the discharge gap.

The first dielectric layer section may extends in the second direction between the inner lines.

A thickness of the first dielectric layer section extending toward the first substrate from the surface of the second substrate may be substantially identical to a thickness of each of the inner lines.

The second dielectric layer section may be integrally formed on the surface of the second substrate between the inner lines and the outer lines, the first dielectric layer section, the inner lines, and the outer lines.

The first electrode and the second electrode may include transparent electrodes on the surface of the second substrate and bus electrodes on the transparent electrodes, the second substrate has a groove corresponding to the discharge gap on the surface of the second substrate facing the first substrate, and the guide portion may be defined by the groove.

The guide portion may be further defined by the transparent electrodes at both sides of the discharge gap and facing each other.

The first dielectric layer section may be between the groove and the transparent electrodes.

A thickness of the first dielectric layer section extending toward the first substrate from a surface of the groove of the second substrate may be substantially identical to a sum of a depth of the groove and a thickness of each of the transparent electrodes.

The second dielectric layer section may be integrally formed on the first dielectric layer section, the transparent electrodes, and the bus electrodes.

A thickness of the first dielectric layer section extending toward the first substrate in the groove of the second substrate may be substantially identical to a sum of a depth of the groove, a thickness of each of the transparent electrodes, and a thickness of a protruding portion that protrudes further than the thickness of each of the transparent electrodes.

The thickness of the protruding portion may be substantially identical to a thickness of each of the bus electrodes.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective schematic view of a plasma display panel according to a first exemplary embodiment of the present invention.

FIG. 2 is a cross-sectional schematic view taken along line II-II of FIG. 1.

FIG. 3 is plan schematic view of a disposition relationship of a display electrode, a first dielectric layer section, and a discharge cell.

FIG. 4 is a cross-sectional schematic view of a plasma display panel (PDP) according to a second exemplary embodiment of the present invention.

FIG. 5 is a cross-sectional schematic view of a plasma display panel (PDP) according to a third exemplary embodiment of the present invention.

FIG. 6 is a cross-sectional schematic view of a plasma display panel (PDP) according to a fourth exemplary embodiment of the present invention.

### DESCRIPTION OF REFERENCE NUMERALS INDICATING CERTAIN ELEMENTS IN THE DRAWINGS

100, 200: Plasma display panel
10: First substrate (Rear substrate)
20: Second substrate (Front substrate)
11: Address electrode
13: First dielectric layer
16: Barrier rib
16a, 16b: First and second barrier rib members
17: Discharge cell
19: Phosphor layer
31, 41, 51: First electrode (Sustain electrode)
32, 42, 52: Second electrode (Scan electrode)
31a, 41a, 51a 32a, 42a, 52a: Transparent electrode
31b, 41b, 51b, 32b, 42b, 52b: Bus electrode
21, 51, 61, 71: Second dielectric layer
211, 511, 611, 711: First dielectric layer section
711a: Protruding portion
212, 512, 612, 712: Second dielectric layer section
23: Protective layer
41a, 42a: Inner line
41b, 42b: Outer line
G: Groove
Tg: Depth
T, T2, T3, T4, Ta, Tb: Thickness

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

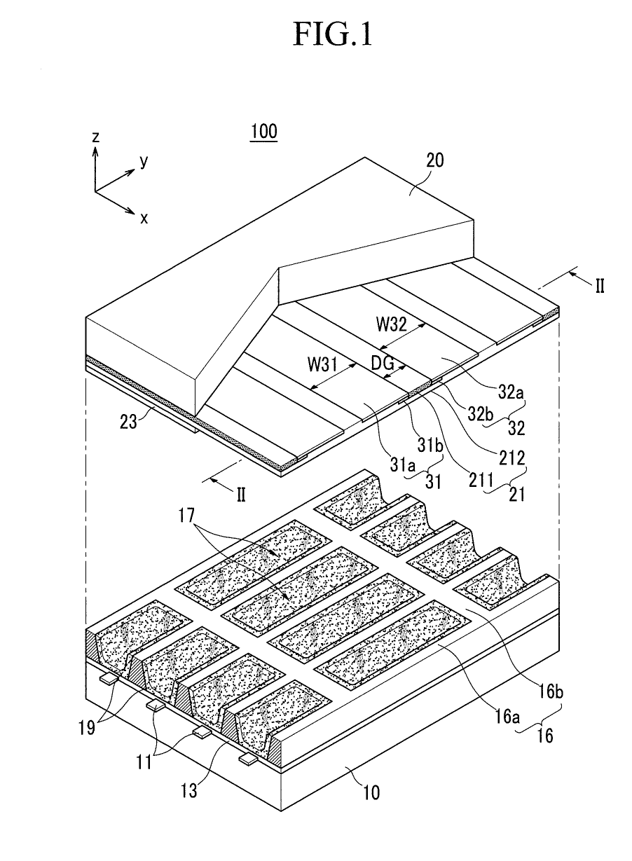

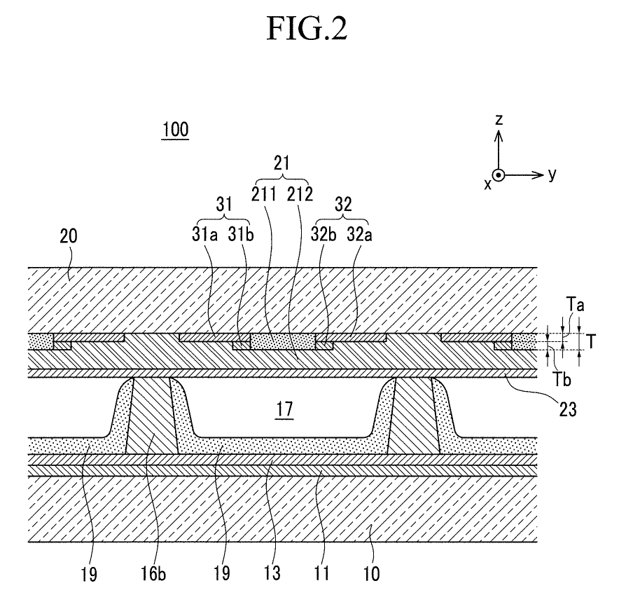

FIG. 1 is an exploded perspective schematic view of a plasma display panel according to a first exemplary embodiment of the present invention. FIG. 2 is a cross-sectional schematic view taken along line II-II of FIG. 1.

Referring to FIGS. 1 and 2, the plasma display panel 100 according to the first exemplary embodiment includes a first substrate (hereinafter, “rear substrate”) 10 and a second substrate (hereinafter, “front substrate”) 20 that are attached to face each other with a space therebetween, and a barrier rib 16 disposed between the front and rear substrates 10 and 20.

The barrier rib 30 partitions a space provided between the rear substrate 10 and the front substrate 20 to form a plurality of discharge cells 17. Phosphor layers 19 are formed in the discharge cells 17 and are filled with discharge gas (i.e., mixed gas containing neon (Ne), xenon (Xe), etc.).

The discharge gas generates vacuum ultraviolet rays by gas discharge. Here, the phosphor layers 19 are excited by the vacuum ultraviolet rays, and then stabilized to emit visible light of red (R), green (G), and/or blue (B). To cause the gas discharge, address electrodes 11 and display electrodes are disposed in the discharge cells 17.

In one example, the address electrodes 11 extend along the surface of the rear substrate 10 facing the front substrate 20 in a first direction (hereinafter, referred to as “y-axis direction”) and correspond to the discharge cells 17 adjacent in the y-axis direction. The plural address electrodes 11 are disposed parallel to the discharge cells 17 adjacent in a second direction (hereinafter, referred to as “x-axis direction”) crossing the y-axis direction.

A first dielectric layer 13 covers the surface of the rear substrate 10 and the address electrodes 11. The first dielectric layer 13 protects the address electrodes 11 from the gas discharge by blocking (or preventing) positive ions or electrons from colliding directly with the address electrodes 11 in discharge. Further, the first dielectric layer 13 provides forming and accumulation spaces of wall charges to enable address discharge by low voltage.

The address electrodes 11 are disposed on the rear substrate 10 so as not to interrupt penetration of the visible light through the front substrate 20. Therefore, the address electrodes 11 may be formed of an opaque electrode, that is, a metal electrode such as silver (Ag) having high electrical conductivity.

The barrier rib 16 is disposed on the first dielectric layer 13 and partition a space between the first dielectric layer 13 and the front substrate 20. For example, the barrier rib 16 includes first barrier rib members 16a that extend along the y-axis direction and second barrier rib members 16b that are disposed to be spaced apart from each other between the first barrier rib members 16a in the y-axis direction and extend in the x-axis direction.

That is, the first barrier rib members 16a partition the discharge cells 17 adjacent in the x-axis direction and the second barrier rib members 16b partition the discharge cells 17 adjacent in the y-axis direction. Therefore, in a quadrangular barrier rib structure, the discharge cells 17 are arranged in a matrix.

The phosphor layers 19 may be formed by applying a phosphor paste onto side surfaces of the first barrier rib members 16a and the second barrier rib members 16b and the surface of the first dielectric layer 13 defined (or surrounded) by the first barrier rib members 16a and the second barrier rib members 16b, and drying and sintering the applied phosphor paste.

The phosphor layers 19 are formed of phosphors that generate visible light of the same color in the discharge cells 17 in the y-axis direction. The phosphor layers 19 are formed of phosphors that generate visible light of red (R), green (G), and blue (B) in the discharge cells 17 in the x-axis direction. That is, the phosphor layers 19 that are formed of the phosphors generating the visible light of red (R), the phosphors generating the visible light of green (G), and the phosphors generating the visible light of blue (B) are repetitively and respectively disposed in the x-axis direction.

The display electrodes include a first electrode (hereinafter, referred to as “sustain electrode”) 31 and a second electrode (hereinafter, referred to as “scan electrode”) 32 formed on the surface of the front substrate 20 facing the rear substrate 10, which correspond to the discharge cells 17. The sustain electrode 31 and the scan electrode 32 form a surface discharge structure in correspondence with each of the discharge cells 17.

The sustain electrode 31 and the scan electrode 32 extend in the x-axis direction crossing the address electrode 11 and are parallel to each other. A discharge gap DG is formed between the sustain electrode 31 and the scan electrode 32. The discharge gap DG corresponds to the center of the discharge cell 17.

For example, the sustain electrode 31 and the scan electrode 32 include the discharge gap DG, transparent electrodes 31a and 32a that form a surface discharge region, and bus electrodes 31b and 32b that apply voltage signals to the transparent electrodes 31a and 32a.

The transparent electrodes 31a and 32a are made of a transparent material (i.e., indium tin oxide (ITO)) to secure an aperture ratio of the discharge cell 17. Further, the bus electrodes 31b and 32b are made of a metallic material having high electrical conductivity on the transparent electrodes 31a and 32a so as to apply the voltage signals to the transparent electrodes 31a and 32a.

The bus electrodes 31b and 32b are formed at both sides of the discharge gap DG on the transparent electrodes 31a and 32a and form the discharge gap DG together with the transparent electrodes 31a and 32a. That is, the discharge gap DG is defined (or established) by the transparent electrodes 31a and 32a on the surface of the front substrate 20 and by the bus electrodes 31b and 32b on the transparent electrodes 31a and 32a, in a z-axis direction.

That is, the metallic bus electrodes 31b and 32b are disposed at about the center of the discharge cell 17 to thereby effectively reduce or prevent voltage drop around the discharge gap DG where a strong electric field is formed at the time of applying the voltage.

A second dielectric layer 21 covers the surface of the front substrate 20, the sustain electrode 31, and the scan electrode 32. The second dielectric layer 21 protects the sustain electrode 31 and the scan electrode 32 from the gas discharge by protecting (or preventing) the positive ions or electrons from colliding directly with the sustain electrode 31 and the scan electrode 32 in discharge. Further, the second dielectric layer 21 provides the forming and accumulation spaces of the wall charges to enable the sustain discharge by the low voltage.

The second dielectric layer 21 includes a first dielectric layer section 211 that is formed between the bus electrodes 31b and 32b and a second dielectric layer section 212 that is formed at both sides of the first dielectric layer section 211 and on the first dielectric layer section 211. In the case in which the sustain electrode 31 and the scan electrode 32 include the transparent electrodes 31a and 32a, the first dielectric layer section 211 may be formed between the transparent electrodes 31a and 32a. That is, the first dielectric layer 211 is formed in the discharge gap DG of the sustain electrode 31 and the scan electrode 32.

The first dielectric layer section 211 has a first dielectric constant and the second dielectric layer section 212 has a second dielectric constant. The first dielectric constant is smaller than the second dielectric constant. Therefore, the first dielectric layer section 211 has a dielectric constant in the discharge gap DG lower than a dielectric constant in parts other than the discharge gap DG.

That is, the first dielectric layer section 211 reduces capacitance between the sustain electrode 31 and the scan electrode 32 by lowering the dielectric constant around the discharge gap DG where the electric field is concentrated at the time of applying the voltage in which the discharge does not occur while driving the plasma display panel 100. As the capacitance is reduced, the reactive power may be reduced.

The bus electrodes 31b and 32b are disposed at both sides of the discharge gap DG. Therefore, when the first dielectric layer section 211 is formed inside of the discharge gap DG, the bus electrodes 31b and 32b guide application and injection of the dielectric paste. That is, the bus electrodes 31b and 32b reduce or prevent the dielectric paste from being applied and injected outside of the discharge gap DG. Accordingly, the bus electrodes 31b and 32b facilitate formation of the first dielectric layer section 211 having a low dielectric constant therebetween and enable precise formation of the first dielectric layer section 211.

That is, since the bus electrodes 31b and 32b are disposed in correspondence with the discharge gap DG, the bus electrodes 31b and 32b form a guide portion for forming the first dielectric layer section 211 at both sides of the discharge gap DG. Further, the transparent electrodes 31a and 32a corresponding to both sides of the discharge gap DG also form the guide portion for forming the first dielectric layer section 211.

Referring to FIG. 2, a thickness T of the first dielectric layer section 211 is established (or extending) toward the rear substrate 10 from the surface of the front substrate 20 and is about (or equal to) a thickness T=Ta+Tb acquired by adding a thickness Ta of the transparent electrodes 31a and 32a and a thickness Tb of the bus electrodes 31b and 32b that are established in the same direction as the thickness T.

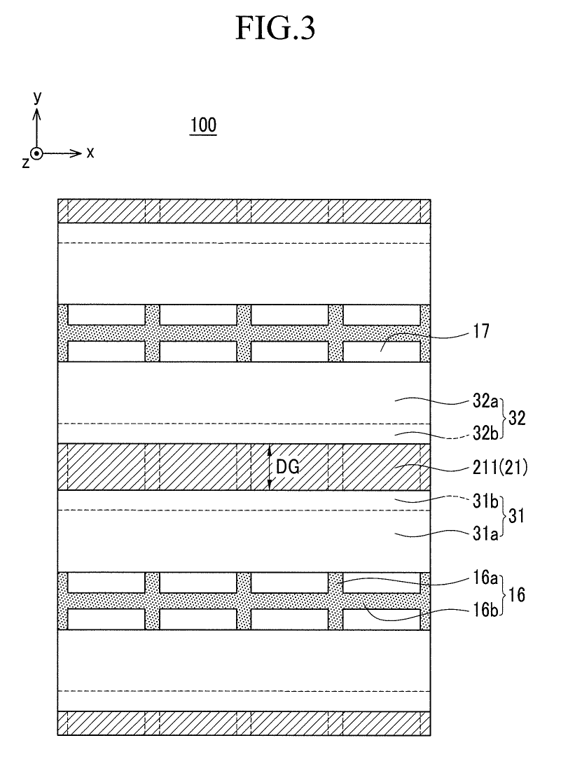

FIG. 3 is plan schematic view of a disposition relationship of a display electrode, a first dielectric layer section, and a discharge cell. Referring to FIG. 3, the first dielectric layer section 211 extends in the x-axis direction in the discharge gap DG between a sustain electrode 31 and a scan electrode 32.

As the transparent electrodes 31a and 32a and the bus electrodes 31b and 32b extend in the x-axis direction and the first dielectric layer section 211 extend in the discharge gap DG, the dielectric paste can be continuously applied by a dispenser, for example. Further, the capacitance is evenly reduced within an entire x-axis direction range of the corresponding discharge cell 17. The first dielectric layer section 211 may be formed by methods such as screen printing, offset printing, inkjet printing, a dispenser, etc.

The transparent electrode may be formed by a protruding electrode that protrudes toward the bus electrode to correspond to each discharge cell. In this case, the first dielectric layer section may extend in the x-axis direction or may be formed at the center of the discharge cell independently corresponding to each of the discharge cells.

Referring back to FIG. 2, the second dielectric layer section 212 covers the surfaces of the first dielectric layer section 211, the sustain electrode 31, the scan electrode 32, and the front substrate 20 to form a flat plane throughout. That is, the second dielectric layer section 212 covers the transparent electrodes 31a and 32a and the bus electrodes 31b and 32b.

A protective layer 23 covers the second dielectric layer section 212. For example, the protective layer 23 is made of transparent MgO that protects the second dielectric layer section 212 in gas discharge and increases a secondary electron emission coefficient.

Reset discharge occurs by a reset pulse applied to the scan electrode 32 during a reset period while driving the plasma display panel 100. Address discharge occurs by a scan pulse applied to the scan electrode 32 and an address pulse applied to the address electrode 11 during an addressing period subsequent to the reset period. Thereafter, sustain discharge occurs by a sustain pulse applied to the sustain electrode 31 and the scan electrode 32 during a sustain period.

The sustain electrode 31 and the scan electrode 32 serve as electrodes that apply the sustain pulse required for the sustain discharge, the scan electrode 32 serves as an electrode that applies the reset pulse and the scan pulse, and the address electrode 11 serves as an electrode that applies the address pulse. The sustain electrode 31, the scan electrode 32, and the address electrode 11 may play different roles depending on a waveform of voltage applied to the electrodes. Therefore, the electrodes may play roles different from the above roles.

The plasma display panel 100 selects a discharge cell 17 to be turned on by the address discharge that occurs by an interaction between the address electrode 11 and the scan electrode 32, and drives the selected discharge cell 17 by the sustain discharge that occurs by an interaction between the sustain electrode 31 and the scan electrode 32 to create or realize an image.

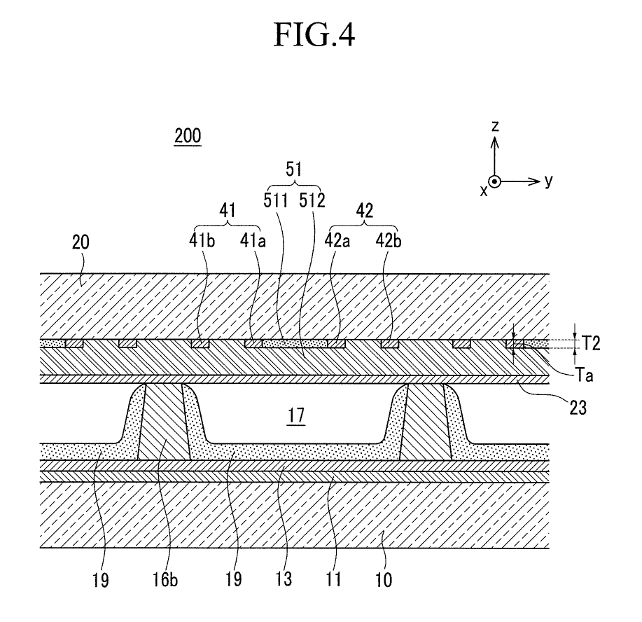

FIG. 4 is a cross-sectional schematic view of a plasma display panel (PDP) according to a second exemplary embodiment of the present invention. Referring to FIG. 4, in the plasma display panel 200 of the second exemplary embodiment, the sustain electrode 41 and the scan electrode 42 may be formed of a metallic bus electrode without the transparent electrodes 31a and 32a, as compared to the first exemplary embodiment.

The bus electrode may be formed of a plurality of metallic lines to have a front aperture ratio of the discharge cell 17 so as to transmit the visible light generated from the discharge cell 17 to the front. For example, the bus electrode, that is, the metallic lines, include inner lines 41a and 42a that establish the discharge gap DG and outer lines 41b and 42b that are formed at sides of the inner lines 41a and 42a away from the discharge gap DG.

A first dielectric layer section 511 has a first dielectric constant and is formed in the discharge gap DG, that is, between the inner lines 41a and 42a. While the inner lines 41a and 42a face each other and form the discharge gap DG, the inner lines 41a and 42a guide the application and injection of the dielectric paste at the time of forming the first dielectric layer section 511.

In the first exemplary embodiment, the transparent electrodes 31a and 32a and the bus electrodes 31b and 32b form a guide portion, while in the second exemplary embodiment, the inner lines 41a and 42a constituting the bus electrode form the guide portion.

A second dielectric layer section 512 has a second dielectric constant higher than the first dielectric constant. The second dielectric layer section 512 is formed on each of the surface of the front substrate 20 between the inner lines 41a and 42a and the outer lines 41b and 42b, the first dielectric layer section 511, the inner lines 41a and 42a, and the outer lines 41b and 42b.

Referring to FIG. 4, a thickness T2 of the first dielectric layer section 511 is established (or extending) toward the rear substrate 10 from the surface of the front substrate 20 and is about (or equal to) a thickness Tb of the inner lines 41a and 42a, which is established in the same direction as the thickness T2 (T2=Tb).

The first dielectric layer section 511 reduces capacitance between the sustain electrode 41 and the scan electrode 42, that is, between the inner lines 41a and 42a, by lowering the dielectric constant around the discharge gap DG where the electric field is concentrated at the time of applying the voltage in which the discharge does not occur while driving the plasma display panel 200. As the capacitance is reduced, the reactive power may be reduced.

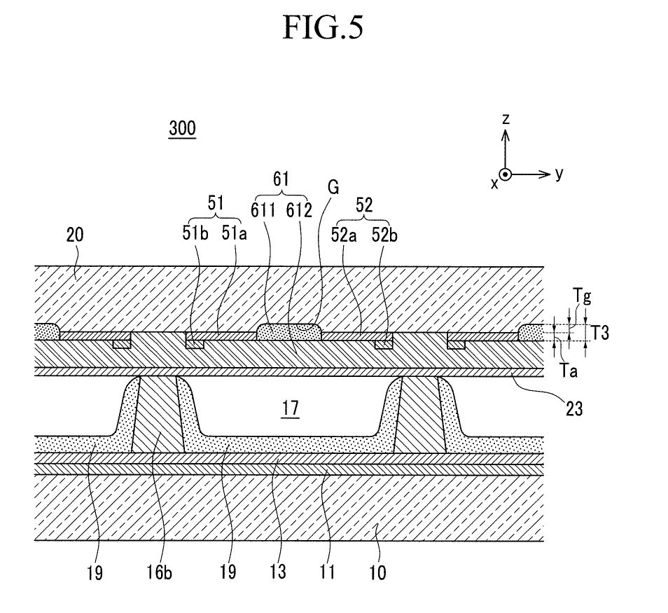

FIG. 5 is a cross-sectional schematic view of a plasma display panel (PDP) according to a third exemplary embodiment of the present invention. Referring to FIG. 5, in the plasma display panel 300 of the third exemplary embodiment, the guide portion is formed, as a groove G, on the surface of the front substrate 20 facing the rear substrate 10 to correspond to the discharge gap DG.

In a sustain electrode 51 and a scan electrode 52, transparent electrodes 51a and 52a form the discharge gap DG of the surface discharge and bus electrodes 51b and 52b are formed on the transparent electrodes 51a and 52a at a position away from the discharge gap DG.

Therefore, the guide portion is further formed of the transparent electrodes 51a and 52a that form both sides of the discharge gap DG in addition to the groove G. That is, the guide portion is established by a space of the groove G and a space between the transparent electrodes 51a and 52a.

In a second dielectric layer 61, a first dielectric layer section 611 is formed between the groove G and the transparent electrodes 51a and 52a; and a second dielectric layer section 612 is integrally formed on the first dielectric layer section 611, the transparent electrodes 51a and 52a, and the bus electrodes 51b and 52b.

A thickness T3 of the first dielectric layer section 611 is established (or extending) toward the rear substrate 10 from a surface of the groove G of the front substrate 20 and is about (or equal to) a sum of a depth Tg of the groove G and a thickness Ta of the transparent electrodes 51a and 52a that are established in the same direction as the thickness T3 (T3=Tg+Ta).

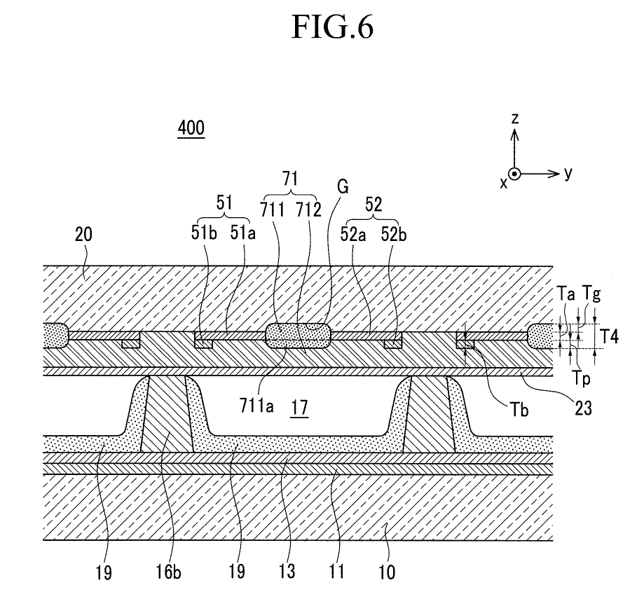

FIG. 6 is a cross-sectional view of a plasma display panel (PDP) according to a fourth exemplary embodiment of the present invention. Referring to FIG. 6, in the plasma display panel 400 of the fourth exemplary embodiment, a thickness T4 of a first dielectric layer section 711 is larger than a thickness T3 of the first dielectric layer section 611 in the third exemplary embodiment.

A thickness T4 of the first dielectric layer section 711 is established toward the rear substrate 10 from a surface of the groove G of the front substrate 20 and is about (or equal to) a sum of a depth Tg of the groove G, a thickness Ta of the transparent electrodes 51a and 52a, and a thickness Tp of a protruding portion 711a that protrudes further than the thickness Ta of the transparent electrodes 51a and 52a that are established in the same direction as the thickness T4 (T4=Tg+Ta+Tp). Further, the thickness Tp of the protruding portion 711a may be about (or equal to) a thickness Tb of the bus electrodes 51b and 52b (Tp=Tb).

The second to fourth exemplary embodiments exemplify various constituent members that have the similar or same effect as the first exemplar embodiment.

According to an exemplary embodiment of the present invention, a dielectric layer of a front substrate is formed by a first dielectric layer section having a comparatively low dielectric constant and a second dielectric layer section having a comparatively high dielectric constant, and the first dielectric layer section having the low dielectric constant is formed in a space of a guide portion (i.e., bus electrodes, transparent electrodes, and/or a groove) that corresponds to a discharge gap, thereby reducing capacitance. Since the capacitance is reduced in the discharge gap or the guide portion, reactive power is reduced.

The guide portion, that is, the bus electrodes and/or the transparent electrodes that are formed at both sides of the discharge gap, and the groove serve as a guide for an applied dielectric paste at the time of forming the first dielectric layer section, such that the first dielectric layer section can be formed accurately and easily.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel, comprising:
a first substrate;
a second substrate facing the first substrate;
a plurality of barrier ribs partitioning a space between the first substrate and the second substrate to define a plurality of discharge cells;
a plurality of address electrodes on a surface of the first substrate facing the second substrate and covered with a first dielectric layer, the address electrodes extending in a first direction to correspond to the discharge cells;
a first electrode and a second electrode extending in a second direction crossing the first direction on a surface of the second substrate facing the first substrate to define a discharge gap at the centers of a corresponding one of the discharge cells and covered with a second dielectric layer; and
a guide portion corresponding to at least a part of the discharge gap,
wherein the second dielectric layer comprises,
a first dielectric layer section within a space defined by the guide portion, and
a second dielectric layer section on the first dielectric layer section, and
wherein the first dielectric layer section has a first dielectric constant and the second dielectric layer section has a second dielectric constant larger than the first dielectric constant.

2. The plasma display panel of claim 1, wherein:
each of the first electrode and the second electrode comprise a bus electrode, and
the guide portion is defined by the bus electrodes at both sides of the discharge gap and facing each other.

3. The plasma display panel of claim 2, wherein:
the first electrode and the second electrode comprise transparent electrodes between the surface of the second substrate and the bus electrodes, and
the guide portion is further defined by the transparent electrodes at both sides of the discharge gap and facing each other.

4. The plasma display panel of claim 3, wherein:
the first dielectric layer section is between the transparent electrodes defining the discharge gap and between the bus electrodes.

5. The plasma display panel of claim 4, wherein:
a thickness of the first dielectric layer section extending towards the first substrate from the surface of the second substrate is substantially identical to a sum of a thickness of each of the transparent electrodes and a thickness of each of the bus electrodes.

6. The plasma display panel of claim 4, wherein:
the first dielectric layer section extends in the second direction in the discharge gap between the first electrode and the second electrode.

7. The plasma display panel of claim 5, wherein:
the second dielectric layer section is on the first dielectric layer section, the bus electrodes, and the transparent electrodes.

8. The plasma display panel of claim 2, wherein:
the bus electrodes are composed of a plurality of metallic lines.

9. The plasma display panel of claim 8, wherein:
the metallic lines comprise,
inner lines defining the discharge gap, and
outer lines at sides of the inner lines away from the discharge gap.

10. The plasma display panel of claim 9, wherein:
the first dielectric layer section extends in the second direction between the inner lines.

11. The plasma display panel of claim 10, wherein:
the thickness of the first dielectric layer section extending toward the first substrate from the surface of the second substrate is substantially identical to a thickness of each of the inner lines.

12. The plasma display panel of claim 10, wherein:
the second dielectric layer section is integrally formed on the surface of the second substrate between the inner lines and the outer lines, the first dielectric layer section, the inner lines, and the outer lines.

13. The plasma display panel of claim 1, wherein:
the first electrode and the second electrode comprise transparent electrodes on the surface of the second substrate and bus electrodes on the transparent electrodes,
the second substrate has a groove corresponding to the discharge gap on the surface of the second substrate facing the first substrate, and
the guide portion is defined by the groove of the second substrate.

14. The plasma display panel of claim 13, wherein:
the guide portion is further defined by the transparent electrodes at both sides of the discharge gap and facing each other.

15. The plasma display panel of claim 14, wherein:
the first dielectric layer section is between the groove and the transparent electrodes.

16. The plasma display panel of claim 15, wherein:
a thickness of the first dielectric layer section extending toward the first substrate from a surface of the groove of the second substrate is substantially identical to a sum of a depth of the groove and a thickness of each of the transparent electrodes.

17. The plasma display panel of claim 16, wherein:
the second dielectric layer section is integrally formed on the first dielectric layer section, the transparent electrodes, and the bus electrodes.

18. The plasma display panel of claim 15, wherein:
a thickness of the first dielectric layer section extending toward the first substrate in the groove of the second substrate is substantially identical to a sum of a depth of the groove, a thickness of each of the transparent electrodes, and a thickness of a protruding portion that protrudes further than the thickness of each of the transparent electrodes.

19. The plasma display panel of claim 18, wherein:
the thickness of the protruding portion is substantially identical to a thickness of each of the bus electrodes.
